(19) United States
(12) Patent Application Publication
(10) Pub. No.: US 2024/0066727 A1
(43) Pub. Date: Feb. 29, 2024

(54) UTILITY KNIFE WITH BUILT-IN FIRE STARTER KIT

(71) Applicant: Jacob Michael Helzer, Kalispell, MT (US)

(72) Inventor: Jacob Michael Helzer, Kalispell, MT (US)

(21) Appl. No.: 18/456,440

(22) Filed: Aug. 25, 2023

Related U.S. Application Data
(60) Provisional application No. 63/401,284, filed on Aug. 26, 2022.

(51) Int. Cl. B26B 11/00; B26B 3/00

(52) U.S. Cl. CPC B26B 11/00; B26B 3/00

(57) ABSTRACT

A knife with an integrated fire-starting kit, characterized by a blade with a tang portion comprising a jimping portion and a striking edge. The handle assembly of the knife, consisting of a removable top cover and a non-removable bottom cover, defines a storage cavity aligned with a slot in the tang portion of the blade. Within this cavity, a fire-starting kit is housed, which includes multiple hollow fuel tablets and a ferrocenium rod. Unique to this invention, a cam lever mechanism, pivotably positioned on a hollow bushing, allows for easy attachment and detachment of the top cover, granting swift access to the fire-starting kit. Additionally, the design incorporates O-ring seals for waterproofing, threaded inserts for fastener engagement, and buffer rings beneath the fastener heads to allow user-defined elevation adjustments ensuring optimal engagement.

### RELATED APPLICATIONS

This application claims the benefit of U.S. Provisional Patent Application Ser. No. 63/401,284 entitled, “A UTILITY KNIFE WITH EASY ACCESS HANDLE AND COMPACT FIRE STARTER”, filed Aug. 26, 2022, which is incorporated herein in its entirety.

### FIELD OF THE INVENTION

The present invention pertains to cutting instruments, specifically to knives designed for outdoor, survival, and tactical applications. More particularly, the invention relates to a multi-functional knife equipped with an integrated fire-starting kit, facilitating both cutting tasks and fire ignition in various environments, thereby reducing the need for carrying separate tools and enhancing the efficiency and convenience of users during wilderness and survival scenarios.

### BACKGROUND OF THE INVENTION

Knives have been one of the oldest tools known to humanity, evolving from sharp rocks and flint to sophisticated blades crafted from advanced materials. Over the millennia, the fundamental design of the knife has remained consistent: a sharp-edged blade connected to a handle. However, the exigencies of modern life and the demands of specialized activities, such as camping, hunting, and survival expeditions, have created a need for multi-functional knives that offer more than just cutting capabilities.

One essential survival skill, particularly in wilderness settings, is the ability to start a fire. Fire provides warmth, a means of cooking food, protection from wild animals, and signals for rescue. Traditional fire-starting methods often require the use of matches or lighters. However, these tools have limitations. They can get wet, malfunction, or be quickly depleted. Moreover, carrying separate fire-starting kits can be cumbersome and inefficient, especially for individuals who need to minimize the weight and volume of their gear.

Several attempts have been made to integrate fire-starting mechanisms into knife designs. Some knives come with a compartment in the handle to store a small lighter or matches. Others feature a strike pad on the blade or handle to use with a flint. While these designs provide added utility, they often suffer from various shortcomings. Lighters and matches can fail, especially when wet. Strike pads can wear out, and the flint can get lost if not secured properly.

Moreover, the mechanisms to access these fire-starting tools in traditional multi-functional knives can be cumbersome, sometimes requiring the user to disassemble parts of the knife requiring tools. In critical situations, where time and ease of use can be vital, such designs are less than ideal. Additionally, many of these integrated solutions do not provide a waterproof storage compartment, leaving the fire-starting tools vulnerable to moisture, which can render them useless.

Considering the aforementioned limitations in the prior art, there is a clear need for an improved knife design that incorporates a reliable fire-starting kit, which is easily accessible, waterproof, and integrates seamlessly with the knife's structure without compromising its primary function as a cutting tool.

The objective of the present invention is to provide a knife with an in-built fire-starting kit that addresses these issues, offering a robust and reliable solution for those in need of both a cutting tool and a fire source, without the common problems associated with previous designs.

A significant challenge in incorporating a fire-starting kit into a knife design is ensuring that the integration does not hinder the knife's primary function or compromise its structural integrity. The added components should not make the knife cumbersome, unwieldy, or prone to breakage.

Another challenge lies in ensuring easy access to the fire-starting kit without requiring elaborate procedures or tools. The user should be able to access the kit quickly and efficiently, especially in emergency situations.

Waterproofing the storage compartment of the fire-starting kit is crucial. Many outdoor activities involve exposure to water, whether it's due to rain, river crossings, or accidental immersion. Protecting the fire-starting tools from moisture is imperative for the kit's reliability.

U.S. Ser. No. 11/415,387B2 introduces a novel fusion between firearms and fire-starting capabilities, highlighting the ever-growing need for multi-purpose tools. This patent showcases a picatinny rail integrated with a fire starter system. Traditionally, a picatinny rail serves as a mounting platform on firearms for sights and other accessories. However, in this innovation, the rail also houses a system capable of delivering flammable material, which when combined with an integrated striker, allows the user to initiate a fire. This marriage between firearms and survival tools underscores the necessity of having immediate access to life-saving utilities in emergency situations.

Similarly, the invention documented in U.S. Pat. No. 8,196,328B2 represents another stride in multi-functional tool design. It describes a compact firearm that can be folded and houses an array of survival tools. The tool showcases a myriad of unique features, ranging from a special hammer actuator mechanism to dual lasers that can be used for signaling in distress situations and target sighting. This patent reiterates the importance of compactness and the integration of diverse tools into a singular device for various survival scenarios.

The patent U.S. Ser. No. 10/464,199B2 focuses on another common tool, the plier, but with an innovative twist. The described multi-purpose tool allows for the handle to be detached and used independently. This introduces an added layer of flexibility to a traditional tool, enabling it to cater to a wider array of tasks.

Knives with added functionalities are further explored in U.S. Ser. No. 10/081,112B2, which details a knife equipped with removable scales that double up as independent tools. This particular design cleverly incorporates a bottle opener into the knife body, further emphasizing the push towards maximizing the utility of everyday tools.

Addressing the ease of assembly and disassembly, US20120017442A1 presents magnetic handle scales for folding tools, like pocketknives. This design not only facilitates easy attachment and detachment of scales but also considers storage solutions by introducing recesses within the scales to safely house various accessories.

Lastly, U.S. Ser. No. 10/773,372B2 unveils a sophisticated scale attachment system for knives, particularly those that come with removable scales. The patent demonstrates the use of U-shaped clips, which are ingeniously designed to snugly fit into grooves on the handle, ensuring that the scales remain firmly in place during use.

While each of the mentioned patents introduces commendable innovations, there persists a tangible gap in the market for a knife that seamlessly integrates an easily accessible fire-starting kit. Furthermore, conventional solutions require a set of tools to access the additional features making it cumbersome for use.

The present invention seeks to fill this void by offering a knife design that synergizes the essential utility of a sharp blade with the primal, life-sustaining capability of starting a fire, all within a single, ergonomically designed unit.

### SUMMARY OF THE INVENTION

In light of the disadvantages mentioned in the previous section, the following summary is provided to facilitate an understanding of some of the innovative features unique to the present invention and is not intended to be a full description. A full appreciation of the various aspects of the invention can be gained by taking the entire specification and drawings as a whole.

The present invention relates to an innovative multifunctional knife that seamlessly incorporates a fire-starting kit, designed to augment its utility while preserving its core function as a cutting instrument. The integration of the fire-starting kit is crafted in a manner that ensures quick access, reliability, and protection against external environmental elements, particularly moisture.

Central to the invention is the knife's blade, which is equipped with a tang portion. This tang portion is distinctively characterized by a rectangular slot and openings tailored to receive fasteners. Attached to this tang portion is a handle assembly, crafted to include both a removable top cover and a fixed bottom cover. Together, these components form a storage cavity which aligns perfectly with the rectangular slot in the blade's tang. Within this storage cavity, users will find the fire-starting kit, thoughtfully comprising multiple hollow fuel tablets and a ferrocenium rod.

A pivotal element of the invention is the cam lever mechanism which is operatively linked to the top cover of the handle assembly. This innovative mechanism boasts a dual-functional design. In its primary position, it effectively engages the top cover with the tang portion of the blade, securing it firmly in place. When shifted to its secondary position, it permits the top cover to disengage from the tang portion, granting the user direct access to the storage cavity and the fire-starting tools contained within.

Certain embodiments of the invention further accentuate its practicality and efficiency. For instance, the handle assembly has been designed with O-ring seals around its storage cavity, providing a waterproof barrier that ensures the fire-starting kit remains functional even in moist conditions. The cam lever mechanism, for ease of use, may be integrated with a cam-shaped grip that's pivotally attached to the blade through a hollow bushing. The removable top cover of the handle assembly showcases fastener cavities having conical profiles that fit snugly into the openings on the blade's tang, ensuring a secure fit. To bolster this attachment, the fasteners, specifically designed for this invention, are equipped with buffer rings. These rings allow for a secure engagement at varying depths within the blade's tang, ensuring that the top cover remains firmly attached, regardless of external pressures or impacts. In addition, a unique design consideration is the dual-purpose hollow fuel tablet. One such tablet not only serves as a grip for the ferrocenium rod but is also constructed of a material that can be used as tinder, further enhancing the kit's fire-starting capabilities.

Furthermore, the invention also delineates a methodical approach to accessing the fire-starting kit housed within the knife. This method underscores the importance of a swift and straightforward process, especially crucial during emergencies or unforeseen circumstances.

In its entirety, the present invention offers a ground-breaking solution for those seeking a multifaceted tool that marries the primary functionality of cutting with the indispensable capability of fire-starting. Every facet of its design underscores ease of use, structural robustness, and resilience against external factors, ensuring that users have a dependable tool in a myriad of situations.

This summary is provided merely for purposes of summarizing some example embodiments, to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description and figures.

The abovementioned embodiments and further variations of the proposed invention are discussed further in the detailed description.

### BRIEF DESCRIPTION OF THE DRAWINGS

FIGS. 1 & 2 are exemplary perspective views 100 and 200 of the knife with in-built fire-starting kit according to the embodiments of the present disclosure.

FIG. 3 is an exploded view 300 of the knife with in-built fire-starting kit according to the embodiments of the present disclosure.

FIG. 4 is an exemplary illustration 400 of the fuel tablets of the fire-starting kit of the knife according to the embodiments of the present disclosure.

FIG. 5 is an exemplary exploded view 500 of the fire-starting kit of the knife according to the embodiments of the present disclosure.

FIG. 6 is an exemplary illustration 600 of the working of the cam lever of the knife with in-built fire-starting kit according to the embodiments of the present disclosure.

FIG. 7 is a sectional view 700 of the handle and the tang portion of the knife with in-built fire-starting kit according to the embodiments of the present disclosure.

FIG. 8 is a cross sectional view 800 depicting a fastener coupling the handle assembly together according to the embodiments of the present disclosure.

### DETAILED DESCRIPTION

In the following description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limited sense, and the scope of the present invention is defined only by the appended claims.

The specification may refer to “an”, “one” or “some” embodiment(s) in several locations. This does not necessarily imply that each such reference is to the same embodiment(s), or that the feature only applies to a single embodiment. Single feature of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments of the present invention reveal a sophisticated and multifunctional knife with an in-built fire-starting kit. This innovative design brings together the primal elements of cutting and fire, making it indispensable for survival enthusiasts, adventurers, and anyone who finds themselves in the great outdoors.

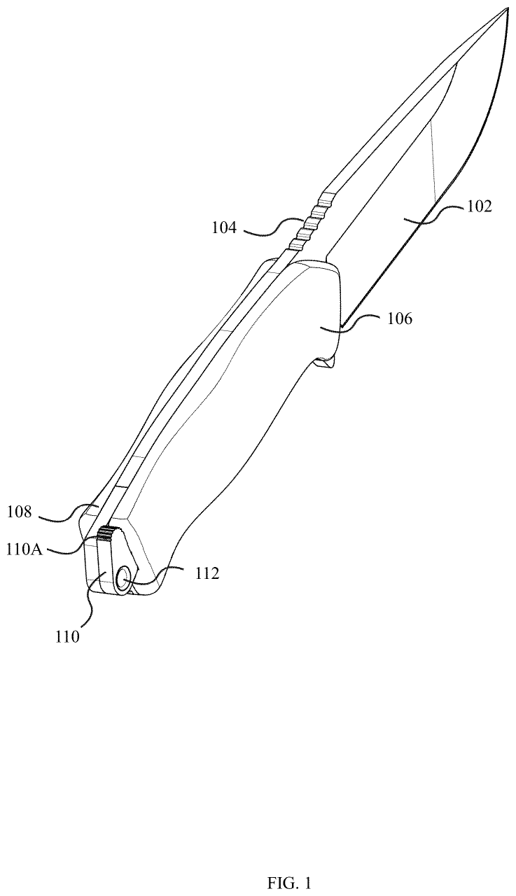

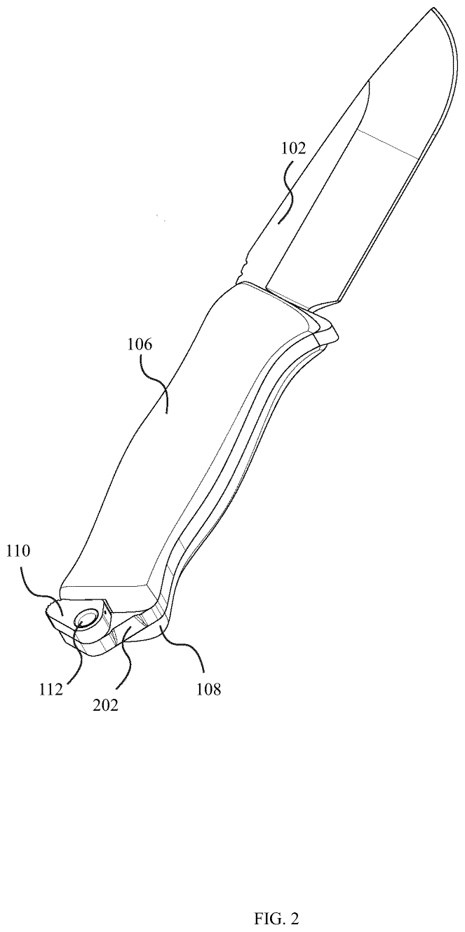

Referring to FIGS. 1 and 2, the present invention is illustrated as a versatile field knife. A primary component is the sharpened blade 102, designed with precision and crafted from robust materials that can range from steel, stainless steel to other durable options like ceramic or titanium. The blade can possess variants, such as serrated edges or blunt tips depending on user preference or specific utility. A jimping portion 104 is meticulously designed at the base of the blade, enhancing grip and control during intricate tasks. A notable feature is the striking edge 202 crafted for efficient functionality.

Further, at the distal end of this field knife, there's an ingeniously designed cam lever 110. Positioned pivotably on a hollow bushing 112, this cam lever ensures that the removable top cover 106 is securely locked into its place, preventing any accidental detachment during use. However, this invention remains adaptable, with alternate embodiments that could include sliding levers or similar mechanisms for securing the top cover. Opposite to this is the bottom cover 108, permanently secured, serving as the base of the handle.

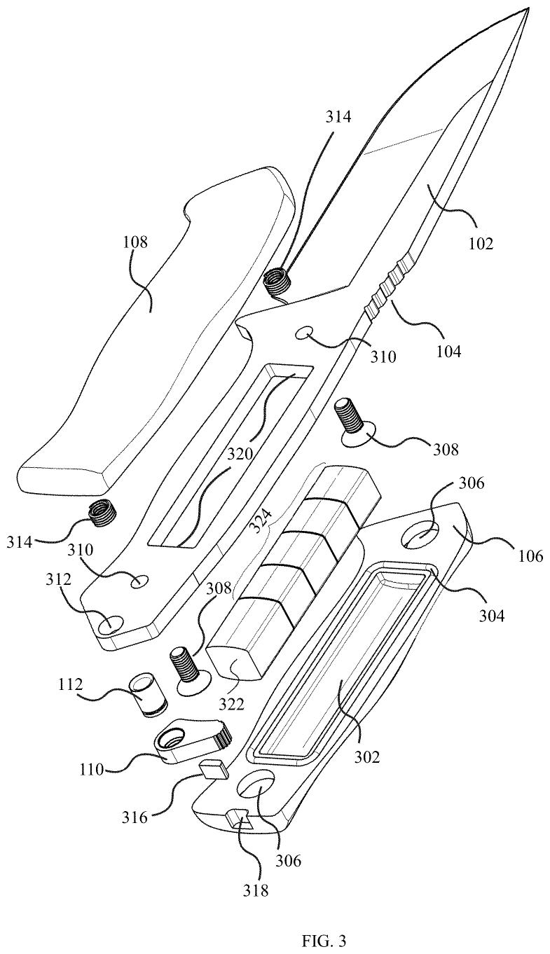

Moving on to FIG. 3, an exploded view offers a more detailed insight. The blade's tang is impeccably secured to the non-removable bottom cover 108. This security is ensured by the use of at least two sturdy fasteners 308 which traverse through the tang's openings 310, engaging effectively with the threads delicately fashioned on the threaded inserts 314 embedded within the bottom cover 108.

Both the removable top cover 106 and the non-removable bottom cover 108 are crafted with a meticulously carved inner portion, together defining a storage cavity 302—a reserved space for essential survival tools. The removable top cover 106 is additionally designed with fastener cavities 306. This top cover 106 is then removably-secured to the knife blade 102 by the operational prowess of the cam lever 110. Ensuring an airtight environment within the storage cavity, a groove runs along the perimeter of storage cavity 302, perfectly configured to host an O-ring 304. The cam lever 110, not just a functional piece but also aesthetically, pleasing, is styled with a cam shape and an ergonomic grip 110A. It is secured to the blade 102 via the hollow bushing 112 that fits snugly into the hole 312 on the blade.

A crucial feature is the retaining portion 318 on the removable top cover, intricately designed to receive a wear plate 316, ensuring longevity and wear-resistance. The cam lobe engages repeatedly with the wear plate 316 while securing the top cover to the tang portion of the knife. The wear plate is strategically placed to withstand repeated instance of friction between the wear plate and the cam lobe. Within this design, the shaped fuel tablets 324 find their place, stacked and aligned inside the blade slot 320, ready for use when needed.

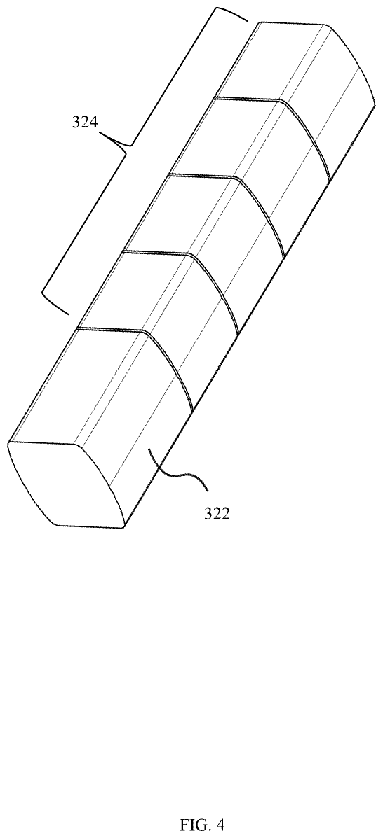

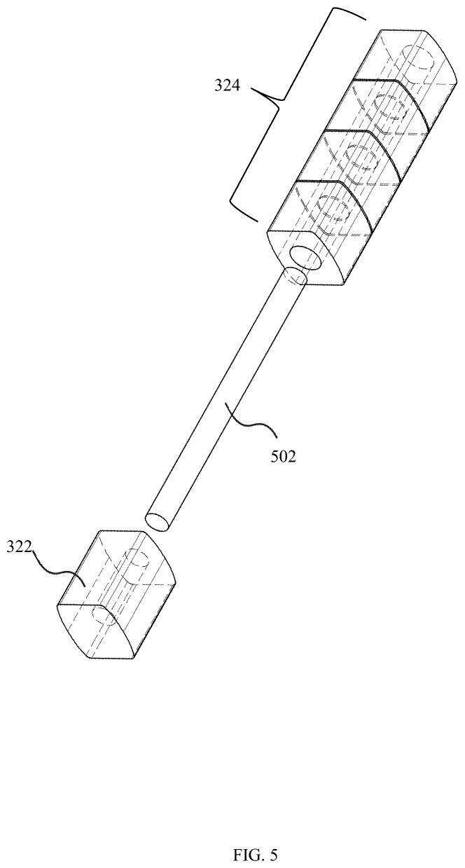

FIGS. 4 and 5 showcase the heart of the survival component—the fire starter kit. A series of file tablets 324, each precisely shaped and designed with proximal apertures, are grouped. These apertures play a pivotal role, enabling the cylindrical-shaped ferrocenium rod 502 to be strategically positioned between them. A functional addition at the distal end of the ferrocenium rod 502 is the grip tablet 322. Made of wood, this tablet can double up as tinder, making fire-starting an efficient task.

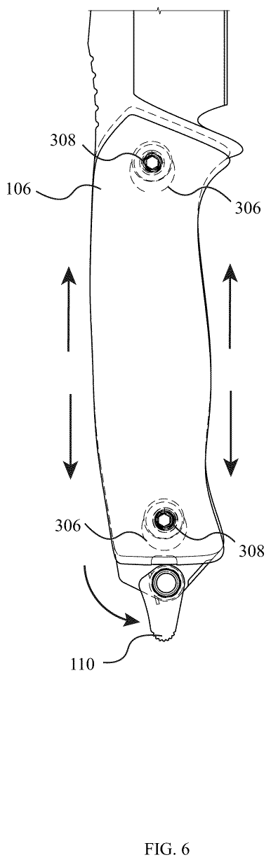

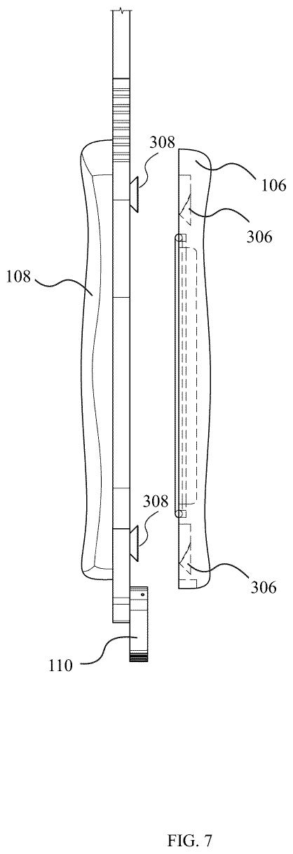

The intricate workings of the cam lever 110 are demonstrated in FIGS. 6 and 7. A simple rotation of the cam lever in a counter clockwise direction disengages the fastener cavities 306 in the top cover 106 from the heads of the fasteners 308, allowing the top cover to be slidably disengaged and removed. Conversely, repositioning the top cover 106 and rotating the cam lever clockwise will lead to a secure engagement between the fastener cavities and the fastener heads. The arrows depict the possible directions of movement of the top cover when they are secured or released.

The engagement between the cam lobe and the wear plate is arranged in such a way that the cam is allowed to rotate slightly past (approximately 10 degrees) the index of maximum pressure between the cam and wear plate. This feature is what causes the cam to “snap” in place, ensuring a secure retention to prevent inadvertent release. To achieve the conical surface in the fastener cavities 306 that aligns with the heads of the fasteners 308, a specialized dovetail machining bit is employed. Separate machined inserts with the conical surface may also be employed.

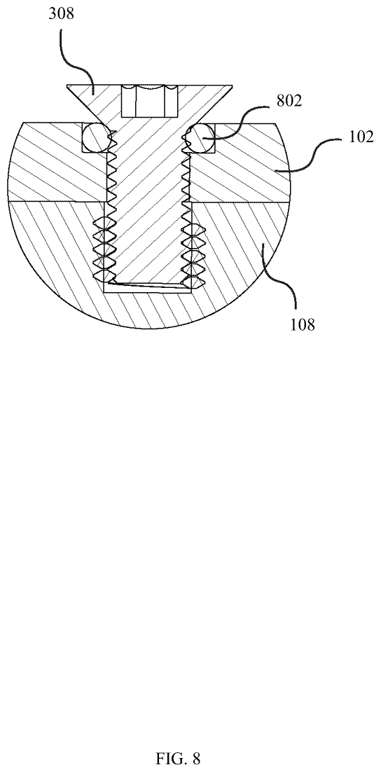

Lastly, FIG. 8 offers a closer look at the fasteners 308 and their countersunk heads. Positioned beneath each fastener head is a buffer ring 802, crafted from materials that are both compressible and wear-resistant, such as Bina-N, Viton, UBMW, or Teflon. These buffer rings serve a dual purpose. Firstly, they ensure that the fasteners, regardless of their depth within the blade 102, remain immobile. Secondly, these rings, when used in conjunction with the fasteners 308, offer a user the flexibility to make elevation adjustments, ensuring optimal engagement between the fasteners 308 and the fastener cavities 306.

In wrapping up this detailed exposition, its evident that this knife with an in-built fire-starting kit isn't just another tool. It's a symphony of design, innovation, and utility. Each component, meticulously represented by its respective numeral, collectively crafts a knife that seamlessly melds the ancient art of fire-making with modern engineering, resulting in a tool truly fit for the 21st-century adventurer.

While contemporary knives feature removable handles, offering users the flexibility to modify or replace the handle as needed, a significant limitation with these designs is the requirement of tools for disassembly, combined with the presence of exposed fasteners that may detract from the aesthetics or ergonomics of the knife. In contrast, the design described herein offers a distinct advantage by providing tool-less access to the fire kit contained within. Moreover, its construction mimics the seamless appearance of traditional fixed blade knife handles that are typically bonded together, such as through gluing or laminating, enhancing both its visual appeal and functional elegance.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All the features disclosed in this specification (including any, accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter.

What is claimed is:

1. A knife with in-built fire starting kit, comprising:
a blade with a tang portion, said tang portion having a rectangular slot and openings adapted to receive fasteners;
a handle assembly configured to attach to said tang portion, said handle assembly including:
a removable top cover and a fixed bottom cover, collectively defining a storage cavity aligned with said rectangular slot provided in the tang portion of the blade; and
a cam lever mechanism operatively connected to said top cover, wherein:
in a first position, the cam lever mechanism engages the top cover with the tang portion of the blade, retaining the top cover securely in place; and
in a second position, the cam lever mechanism disengages the top cover from the tang portion of the blade, allowing for access to the storage cavity; and
a fire-starting kit housed within the storage cavity, the fire-starting kit comprising multiple hollow fuel tablets and a ferrocenium rod.

2. The knife with in-built fire starting kit of claim 1, wherein the handle assembly further comprises O-ring seals around the perimeter of the storage cavity, making the storage cavity waterproof.

3. The knife with in-built fire starting kit of claim 1, wherein the cam lever mechanism comprises a cam-shaped grip pivotally connected to said blade via a hollow bushing.

4. The knife with in-built fire starting kit of claim 1, wherein the removable top cover comprises fastener cavities having conical profiles aligning to the openings provided on the tang portions of the blade.

5. The knife with in-built fire starting kit of claim 1, wherein the fasteners include buffer rings for maintaining secure engagement between the fasteners and the top cover at variable depths within the blade's tang.

6. The knife with in-built fire starting kit of claim 1, wherein at least one of the multiple hollow fuel tablet acts as a grip for the ferrocenium rod and is composed of a material suitable for use as tinder.

8. The knife with in-built fire starting kit of claim 1, wherein engagement of a cam lobe with a wear plate allows the cam lever to rotate about 10 degrees past the point of maximum pressure between the cam lever and wear plate, retaining the top cover securely in place.

8. A method of accessing a fire-starting kit in a knife, comprising the steps of:
providing a knife having a blade with a tang portion with a rectangular slot and openings adapted to receive fasteners;
providing a handle assembly attached to said tang portion, where the handle assembly includes a removable top cover and a fixed bottom cover, collectively defining a storage cavity aligned with said rectangular slot in the tang portion of the blade;
operating a cam lever mechanism connected to said top cover to move from a first position wherein the cam lever mechanism retains the top cover securely to the tang portion of the blade, to a second position wherein the cam lever mechanism allows the top cover to disengage from the tang portion of the blade; and
accessing a fire-starting kit housed within said storage cavity.

9. The method of claim 8, further comprising the step of sealing the perimeter of the storage cavity with O-ring seals, thereby making the storage cavity waterproof.

10. The method of claim 8, wherein operating the cam lever mechanism involves using a cam-shaped grip pivotally connected to said blade via a hollow bushing.

11. The method of claim 8, wherein the removable top cover engages with the tang portion of the blade through fastener cavities with conical profiles aligning to the openings on the tang portion of the blade.

12. The method of claim 8, wherein securing the removable top cover to the blade's tang involves utilizing fasteners with buffer rings to maintain secure engagement at variable depths within the blade's tang.

13. The method of claim 8, further comprising the steps of:
removing at least one hollow fuel tablet from the storage cavity, which also acts as a grip for a ferrocenium rod; and
utilizing said hollow fuel tablet as tinder for fire starting.
